(19) United States
(12) Patent Application Publication
(10) Pub. No.: US 2019/0028290 A1
(43) Pub. Date: Jan. 24, 2019

(54) HOME AUTOMATION CONTROL SYSTEM USING FACE RECOGNITION, AND METHOD THEREFOR

(71) Applicant: FIVEGT CO., LTD., Seoul (KR)

(72) Inventor: Gyu Taek JEONG, Seongnam-si (KR)

(73) Assignee: FIVEGT CO., LTD., Seoul (KR)

(21) Appl. No.: 16/068,969

(22) PCT Filed: Jan. 9, 2017
(86) PCT No.: PCT/KR2017/000249

§ 371 Date: Jul. 10, 2018

(30) Foreign Application Priority Data
Jan. 13, 2016 (KR) 10-2016-0004192

(51) Int. Cl. H04L 12/28; G07C 9/00

(52) U.S. Cl. CPC H04L 12/282; G06K 9/00288; H04L 2012/285; G07C 9/00087

(57) ABSTRACT

The present invention relates to a home automation control system and method using face recognition. The present invention includes a face recognition device configured to compare a photographed authentication image of a user's face with a plurality of previously stored face images to perform authentication for user entering a house, a face recognition server configured to receive authenticated user information from the face recognition device and transmit access information for informing whether or not the user enters the house to a user terminal corresponding to the user information, and a home electronic device control unit configured to control the home electronic devices according to preset reservation information from a user when activated by the home automation activation unit, thereby operating the home electronic devices to correspond to the reservation information set by the user according to the user's access.

### TECHNICAL FIELD

The present invention relates to a home automation control system and method using face recognition, and more particularly, to a home automation control system and a method thereof, which use face recognition to check whether or not a user is entering using face recognition, and to operate home electronic appliances according to reservation information of an entering user.

### BACKGROUND ART

Recently, with the development of home automation technology, home electronic appliances including a lamp, a boiler, an air conditioner, an audio and a TV may be remotely controlled using the Internet or a smart phone, so that users may live more conveniently.

Especially, as providing a reservation function such as turning on the light according to the time when the user arrives and operating the boiler and the air conditioner to adjust the temperature of the room before the user arrives, the conventional home automation system may further improve the user's convenience.

Meanwhile, in the case of a conventional home automation system, since each household electronic device is operated on the basis of only the time reserved by the user, even if the user does not arrive home on time because the user is later than usual, there is a problem that the household electronic device operates and wastes electricity irrespective of whether or not the user enters.

Further, since the conventional home automation system is not able to identify a user who exists in the room or goes in and out, it is very difficult for a plurality of family members to make a reservation setting for each individual preference or to control the household electronic device.

### DISCLOSURE OF THE INVENTION

### Technical Problem

An object of the present invention is to provide a home automation control system using facial recognition, which is capable of identifying a user entering by using face recognition and operating domestic electronic devices according to the reservation information of the user, and a method thereof.

The objects of the present invention are not limited to the above-mentioned objects, and other objects not mentioned may be clearly understood by those skilled in the art from the following description.

### Technical Solution

In accordance with an embodiment of the present invention, a home automation control system using face recognition includes: a face recognition device configured to compare a photographed authentication image of a user's face with a plurality of previously stored face images to perform authentication for user entering a house; a face recognition server configured to receive authenticated user information from the face recognition device and transmit access information for informing whether or not the user enters the house to a user terminal corresponding to the user information; and a user terminal configured to control home electronic devices according to preset reservation information when receiving the access information from the face recognition server and confirming the user's indoor access.

The user terminal may include: a home automation activation unit configured to receive access information from the face recognition server and activate a home electronic device control unit in real time when the user's indoor access is confirmed; and a home electronic device control unit configured to control the home electronic devices according to preset reservation information from a user when activated by the home automation activation unit.

The home electronic device control unit may be provided for each home electronic device and installed in a user terminal, and remotely control home electronic devices to be turned on or off or perform a reserved operation according to the reservation information.

The home electronic devices may include at least one of a light, a boiler, an audio, a TV, an air conditioner, a water control device, a gas control device, and a security device.

The home automation activation unit may store information on a home electronic device control unit to be activated in real time when a user's indoor access is confirmed.

In accordance with another embodiment of the present invention, provided is a home automation control method performed in a home automation control system using face recognition. The method includes: (1) comparing, by a face recognition device, a photographed authentication image of a user's face with a plurality of previously stored face images to perform authentication for user entering a house; (2) receiving, by a face recognition server, authenticated user information from the face recognition device, and transmitting access information for informing whether or not the user enters the house to a user terminal corresponding to the user information; and (3) receiving, by a user terminal, the access information from the face recognition server and controlling home electronic devices according to preset reservation information.

The user terminal of step (3) may include a home automation activation unit for receiving access information from a face recognition server and a home electronic device control unit activated by the home automation activation unit, wherein step (3) may include: (3-1) receiving, by the home automation activation unit, access information from the face recognition server and activating a home electronic device control unit in real time after the user's indoor access is confirmed; and (3-2) controlling, by the home electronic device control unit, the home electronic devices according to reservation information preset by a user.

In step (3-2), the home electronic device control unit may be provided for each home electronic device and remotely control home electronic devices to be turned on or off or perform a reserved step according to the reservation information.

In step (3-2), the home electronic device may include at least one of a light, a boiler, an audio, a TV, an air conditioner, a water control device, a gas control device, and a security device.

The method may further include step of (A) wherein the home automation activation unit storing information on a home electronic device control unit to be activated in real time when a user's indoor access is confirmed, before step (1).

### Advantageous Effects

The present invention according to the above-mentioned problem solving means includes a face recognition device for performing authentication for indoor access, a face recognition server for transmitting access information to a user terminal of a user who completes authentication, a home automation activation unit that is installed in the user terminal and activates the home electronic device control unit in real time when the user enters inside, and a home electronic device control unit for controlling the home electronic device [symbol] according to the reservation information preset by the user when the home automation activation unit activates the home electronic device control unit, so that there is an effect that the household electronic device may be operated according to the reservation information set by the user according to whether or not the user enters a house.

Also, since the home electronic devices operate when the user enters the house, the present invention may prevent the household electronic devices from unnecessarily wasting electricity when operating the household electronic devices.

Also, when family members make reservation information according to their preferences, the present invention may operate home electronic devices based on the reservation information according to whether or not each family member enters the house.

### BRIEF DESCRIPTION OF THE DRAWINGS

FIG. 1 is a view for explaining a home automation control system according to an embodiment of the present invention.

FIG. 2 is a view for explaining a process of operating a home electronic device using a home automation control system.

FIG. 3 is a view for explaining a home automation control method according to an embodiment of the present invention.

### MODE FOR CARRYING OUT THE INVENTION

In the following description, specific details of the present invention are set forth in order to provide a more thorough understanding of the present invention, and it will be apparent to those skilled in the art that the present invention is easily implemented without these specific details and with modifications thereto.

First, a home automation activation unit and a home electronic device control unit constituting a home automation control system according to an embodiment of the present invention may be implemented in hardware, but preferably in software that operates together with hardware.

Here, the software may be installed in a user terminal to operate, and the user terminal may be provided in a server device accessible through a wired or wireless communication network or the Internet network to operate.

Moreover, the user terminal may include personal computers, smart phones, and tablet PCs as well as industrial and personal computer devices that are customized according to the purpose of the user terminal and preferably, may be a smart phone.

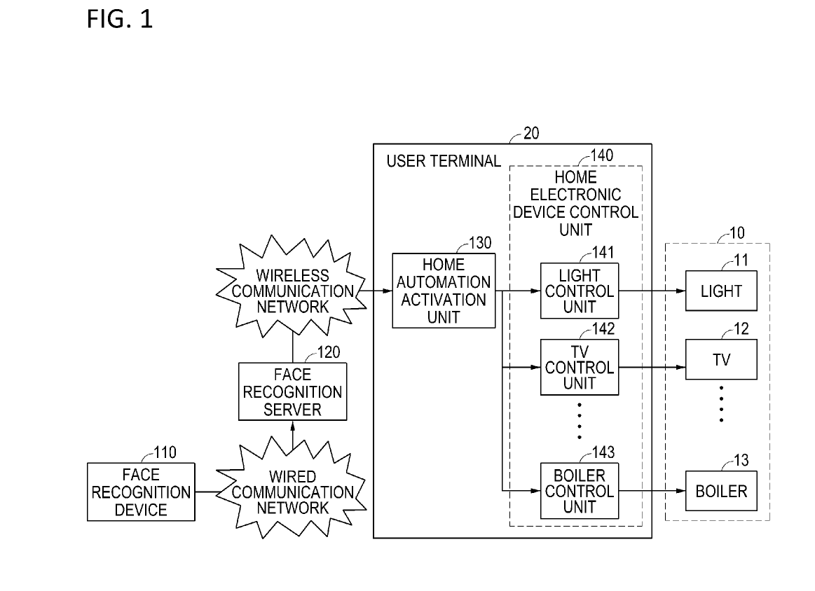

Hereinafter, preferred embodiments of the present invention will be described in detail with reference to FIGS. 1 to 3, and the description is given on the parts necessary for understanding the operations and functions according to the present invention.

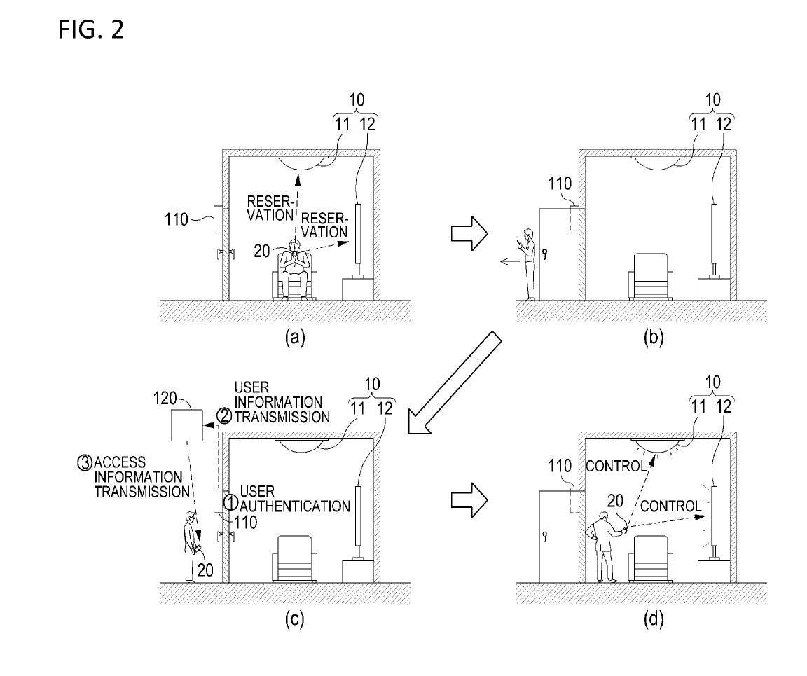

FIG. 1 is a view for explaining a home automation control system according to an embodiment of the present invention, and FIG. 2 is a view for explaining a process of operating a home electronic device using a home automation control system.

Referring to FIGS. 1 and 2, a home automation control system according to an embodiment of the present invention includes a face recognition device 110, a face recognition server 120, a home automation activation unit 130, and a home electronic device control unit 140.

Here, the home automation control system according to an embodiment of the present invention performs authentication of entering family members to identify a corresponding family member, and then, after identifying the family member, operates the home electronic devices 10 constituting home automation system according to the reservation information previously reserved by the identified family member.

At this time, the home electronic devices 10 described above may include various electronic devices that may exist or be installed in a home, such as a lamp, a boiler, an audio, a TV, an air conditioner, a water control device, a gas control device, and a security device.

The face recognition device 110 recognizes a user and performs authentication for the user. The face recognition device 110 compares a photographed authentication image of a user's face with a plurality of previously stored face images, and performs authentication for indoor access.

That is, the face recognition device 110 is individually provided for each family, so that when a family member of the home is trying to enter the house, the face recognition device 110 recognizes the face of the family member and performs authentication to release the lock state of the door lock according to the authentication result.

Additionally, when the authentication of the family member or the user is completed, the face recognition device 110 transmits the user information of the authenticated subject to the face recognition server 120 through a wired communication network or the Internet network. Accordingly, the face recognition server 120, which will be described later, may confirm the user entering the house, and transmit access information to the user terminal 20 of the corresponding user.

Meanwhile, the face recognition device 110 may further include functions for detecting a voice or wireless signal including identification information composed of at least one of a predetermined word, a Bluetooth signal, an NFC tag, and an RFID tag to recognize whether or not a user accesses, selecting a face image matching the identification information among the previously stored face images, and adjusting the angle of the camera according to the user's height using the identification information.

The face recognition server 120 is for relaying the face recognition device 110 and the user terminal 20, and performs functions for transmitting the access information to the user terminal 20 to inform the user whether the user is in the house after receiving the authenticated user information from the face recognition device 110.

For example, the face recognition server 120 receives user information from the face recognition device 110 installed in a plurality of homes through a wired communication network or the Internet network, and transmits access information to each user's user terminal 20 through a wireless communication network or a mobile communication network.

On the other hand, the face recognition server 120 stores information on users stored in the face recognition device 110 and information on the user terminal 20 held by each user which is linked to the information on user in advance.

The home automation activation unit 130 is installed in the user terminal 20 and performs functions for receiving access information from the face recognition server 120 verifying whether the user is in the house or not by using the received access information, and activating the home electronic device control unit 140 in real time.

For this, in the home automation activation unit 130, the information on the home electronic device control unit 140, which is to be activated in real time when a user enters the house, is set and stored in advance by user input.

For example, if the home electronic device control unit 140 including a light control unit 141, a TV control unit 142 and a boiler control unit 143 is installed in the user terminal 20 of the user, the user may set all the control units 141, 142, and 143 to be activated through the home automation activation unit 130 when the user comes back home or select and set the light control unit 141 and the TV control unit 142 among all the control units 141, 142 and 143.

In addition, if the home electronic device control unit 140 waits in the sleep mode and is activated by the home automation activation unit 130, it switches to the operation mode to control the home electronic devices 10.

Meanwhile, the home automation activation unit 130 may be implemented as an application program (APP) installed in the user terminal 20, for example, a smart phone.

The home electronic device control unit 140 is for remotely controlling home electronic devices 10 existing or installed in a user's home, and is installed in the user terminal 20. When the home automation activation unit 130 switches the home electronic device control unit 140 from the sleep mode to the operation mode, it allows the home electronic device 10 to be turned on or off or to perform a reserved operation according to a user input inputted in real time or predetermined reservation information.

Preferably, the home electronic device control unit 140 may be implemented as a commercial APP that is provided from a manufacturer or a vendor of the home electronic devices 10 to remotely control the home electronic devices 10.

Also, the home electronic device control unit 140 allows the user terminal 20 to transmit a wireless signal with a control command corresponding to user input or reservation information through wireless communication including RF communication, infrared communication, and Bluetooth and allows the home electronic devices 10 to receive the wireless signal and perform an operation corresponding to the control command, thereby controlling the home electronic devices 10 remotely.

Meanwhile, the home electronic device control unit 140 may be implemented to transmit a control command to the home electronic devices 10 through the Internet network, or when a separate controller for integrally managing the home electronic devices 10 exists, may transmit a control command to the corresponding controller.

Also, the home electronic device control unit 140 is provided for each type of the home electronic device 10, and, for example, may include a light control unit 141 for setting control and reservation information of the light 11, a television (TV) control unit 142 for setting control and reservation information of the TV 12, and a boiler control unit 143 for setting control and reservation information of the boiler control unit 13. In addition, the home electronic device control unit 140 may be further provided with control units for controlling the audio, the air conditioner, the water control device, the gas control device, and the security device, respectively.

Hereinafter, a process of operating home electronic devices according to whether a user enters using a home automation control system according to an embodiment of the present invention will be described.

As shown in FIG. 2, a user may use the user terminal 20 to reserve the home electronic devices 10 to be operated when the user comes back home (a).

At this time, as described with reference to FIG. 1, the user operates the light control unit 141 and the TV control unit 142 installed in the user terminal 20 to set the reservation information to turn on the light 11 in the light control unit 141 and set the reservation information to turn on the TV 12 with the specific channel in the TV control unit 142 and then terminates. In addition, the user may operate the home automation activation unit 130 to set the light control unit 141 and the TV control unit 142 to be activated when the user returns home.

Referring again to FIG. 2, after the user leaves the house (b), if the user comes back home and tries to enter the house (c), the face recognition device 110 recognizes the face of the user and performs authentication, releases the lock state of the door lock according to the authentication result, and transmits the user information of the authenticated object to the face recognition server 120. The face recognition server 120 receives user information and transmits access information to the user terminal 20 corresponding to the user information.

In addition, the home automation activation unit 130 installed in the user terminal 20 receives access information from the face recognition server 120 to confirm the user's access to the house and activate the preset light control unit 141 and TV control unit 142.

Because of this, when the user enters the house (d), the light control unit 141 and the TV control unit 142 installed in the user terminal 20 operate and turn on the light 11 according to each reservation information and control the TV 12 to be turned on with a specific channel reserved in advance.

Therefore, since the home automation control system according to the embodiment of the present invention may operate the home electronic devices 10 according to whether the user enters or not, it is possible to prevent electric waste caused by unnecessary operation of the home electronic devices 10 in a situation where the user is out of the house.

Also, when a user or family member returns home, the home automation control system according to an embodiment of the present invention may turn on the home electronic devices 10 or perform the reserved operation according to the reservation information set for each family member's preference.

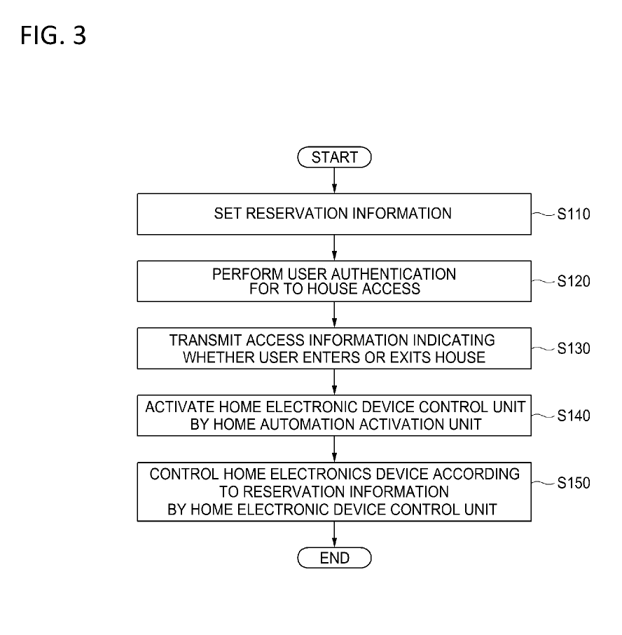

FIG. 3 is a view for explaining a home automation control method according to an embodiment of the present invention.

Referring to FIG. 3, a home automation control method performed in a home automation control system according to an embodiment of the present invention will be described.

However, since the functions performed in the home automation control method shown in FIG. 3 are all performed in the home automation control system described with reference to FIGS. 1 and 2, without an explicit explanation, it should be noted that the functions described with reference to FIGS. 1 and 2 are all performed through a home automation control method according to a preferred embodiment of the present invention, and the functions described with reference to FIG. 3 are all performed through the home automation control system according to the preferred embodiment of the present invention.

First, a user sets the home electronic device control unit to be activated in real time when a user's indoor access is confirmed and stores it through the home automation activation unit (S110).

At this time, the home automation activation unit may be installed in a user terminal owned by the user and may be configured to set and manage the home electronic device control unit according to a user input.

In addition, the home electronic devices may include a light, a boiler, an audio, a TV, an air conditioner, a water control device, a gas control device and a security device, and the home electronic device control unit is provided for each of the light, the boiler, the audio, the TV, the air conditioner, the water control device, the gas control device, and the security device to set reservation information for performing an on-off or specific operation.

In other words, the user may set reservation information for each home electronic device through the home electronic device control unit, and set a specific home electronic device control unit to be activated through the home automation activation unit when the user returns home.

Next, when the user comes back home and tries to enter the house, the face recognition device performs authentication of the user (S120).

In this case, the face recognition device compares a photographed authentication image of a user's face with a plurality of previously stored face images to perform authentication for user's indoor access, and releases the door lock according to the authentication result and transmits the authenticated user information to the face recognition server.

Then, after the face recognition server receives the authenticated user information from the face recognition device, it transmits access information indicating whether the user enters the house to the user terminal interlocked with the user information (S130).

Then, the home automation activation unit installed in the user terminal receives access information from the face recognition server, and activates the home electronic device control unit in real time when the user's indoor access is confirmed through the access information S140.

At this time, the home automation activation unit may activate the home electronic device control unit set in step S110.

Then, the home electronic device control unit operates to control the home electronic device according to the preset reservation information from the user (S150).

At this time, the home electronic device control unit remotely controls to turn on or off a home electronic device or perform a reservation operation according to preset reservation information. For example, the home electronic device control unit turns on the light of a specific position, operates the air conditioner at a predetermined temperature and turns on the TV with a preset channel.

That is, as the reservation operation of the home electronic device is performed according to the reservation information previously set by the user according to whether or not the user enters, it is possible to improve convenience for the user and to prevent waste of unnecessary electricity.

While the preferred embodiments of the present invention are described exemplarily, the scope of the present invention is not limited to these specific embodiments and is appropriately changed within the scope of the claims.

1. A home automation control system using face recognition comprising:
a face recognition device configured to compare a photographed authentication image of a user's face with a plurality of previously stored face images to perform authentication for user entering a house;
a face recognition server configured to receive authenticated user information from the face recognition device and transmit access information for informing whether or not the user enters the house to a user terminal corresponding to the user information; and
a user terminal configured to control home electronic devices according to preset reservation information when receiving the access information from the face recognition server and confirming the user's indoor access.

2. The system of claim 1, wherein the user terminal comprises:
a home automation activation unit configured to receive access information from the face recognition server and activate a home electronic device control unit in real time when the user's indoor access is confirmed; and
a home electronic device control unit configured to control the home electronic devices according to preset reservation information from a user when activated by the home automation activation unit.

3. The system of claim 2, wherein the home electronic device control unit is provided for each home electronic device and installed in a user terminal, and remotely controls home electronic devices to be turned on or off or perform a reserved operation according to the reservation information.

4. The system of claim 2, wherein the home electronic devices comprises at least one of a light, a boiler, an audio, a TV, an air conditioner, a water control device, a gas control device, and a security device.

5. The system of claim 2, wherein the home automation activation unit stores information on a home electronic device control unit to be activated in real time when a user's indoor access is confirmed.

6. A home automation control method performed in a home automation control system using face recognition, the method comprising:
(1) comparing, by a face recognition device, a photographed authentication image of a user's face with a plurality of previously stored face images to perform authentication for user entering a house;
(2) receiving, by a face recognition server, authenticated user information from the face recognition device, and transmitting access information for informing whether or not the user enters the house to a user terminal corresponding to the user information; and
(3) receiving, by a user terminal, the access information from the face recognition server and controlling home electronic devices according to preset reservation information.

7. The method of claim 6, wherein the user terminal of step (3) comprises a home automation activation unit for receiving access information from a face recognition server and a home electronic device control unit activated by the home automation activation unit,
wherein step (3) comprises:
(3-1) receiving, by the home automation activation unit, access information from the face recognition server and activating a home electronic device control unit in real time after the user's indoor access is confirmed; and
(3-2) controlling, by the home electronic device control unit, the home electronic devices according to reservation information preset by a user.

8. The method of claim 7, wherein in step (3-2), the home electronic device control unit is provided for each home electronic device and remotely controls the home electronic devices to be turned on or off or perform a reserved operation according to the reservation information.

9. The method of claim 7, wherein in step (3-2), the home electronic device comprises at least one of a light, a boiler, an audio, a TV, an air conditioner, a water control device, a gas control device, and a security device.

10. The method of claim 7, before step (1), further comprising (A) wherein the home automation activation unit storing information on a home electronic device control unit to be activated in real time when a user's indoor access is confirmed.
